(19) United States
(12) Patent Application Publication
(10) Pub. No.: US 2019/0196576 A1
(43) Pub. Date: Jun. 27, 2019

(54) VIRTUAL REALITY DEVICE AND A VIRTUAL REALITY SERVER

(71) Applicant: Nokia Technologies Oy, Espoo (FI)

(72) Inventors: Jukka SAARINEN, Nokia (FI); Tero JOKELA, Tampere (FI)

(21) Appl. No.: 16/194,849

(22) Filed: Nov. 19, 2018

(30) Foreign Application Priority Data
Dec. 1, 2017 (FI) 20176084

(51) Int. Cl. G06F 3/01; G06T 19/00; G06K 9/00; G06K 9/32

(52) U.S. Cl. CPC G06F 3/011; G06K 9/3233; G06K 9/00671; G06T 19/006

(57) ABSTRACT

The invention relates to a method comprising: transmitting viewing parameters associated with displayed virtual reality content to a virtual reality server by a virtual reality device, and receiving scent instructions from the server for providing a first scent associated with a first region of interest in the content and being determined based on scent preference information associated with the device, and to a method comprising: receiving viewing parameters associated with the content from a plurality of users, determining at least one region of interest in the content based on the received viewing parameters, obtaining scent information for at least one first user, determining a first scent on basis of the scent information of the first user, and providing scent instructions comprising instructions for the device to provide the first scent associated with the region of interest in the virtual reality content. The invention further relates to apparatuses arranged to perform the methods.

### BACKGROUND

A heat map is a visual representation of where users of virtual reality devices are looking at in virtual reality content. It is an overlay giving a sense of where the users are spending the most time gazing. The color spectrum may be used to help to visually interpret engagement of the heat map. Heat maps show how looking and gazing are distributed over the stimulus. Heat maps are a visualization that can effectively reveal the focus of visual attention for dozens or even hundreds of participants at a time.

There are many everyday service providers who can find value from heat maps. Data-driven marketers are often interested in heat maps, because they could be used, for example, for developing placement of goods in markets. The real estate agent can use a heat map to see if certain furniture is getting viewed during a home tour. If not, the agent could move a hotspot with a close-up of the furniture and description of it on there. The educator could utilize a heat map to see where students are focused during their virtual tour of an art museum. The building designer can see what parts of their 3D rendered buildings are drawing the most interest from future tenants, informing the construction before it actually happens.

In general, there are many application areas for heat maps, for example, marketing, advertising, education, learning, entertainment and games. But there exists many application areas, which cannot take advantage of heat maps at all, as such or at least not in the best possible way.

### SUMMARY

Now there has been invented improved methods and technical equipment implementing the methods, by which the above problems are alleviated. Various aspects of the invention include methods, an apparatus, a server, and a computer readable medium comprising a computer program stored therein, which are characterized by what is stated in the independent claims. Various embodiments of the invention are disclosed in the dependent claims.

According to a first aspect, there is provided a method comprising: transmitting viewing parameters associated with displayed virtual reality content to a virtual reality server by a virtual reality device, and receiving scent instructions from the virtual reality server for providing a first scent, wherein the first scent is associated with a first region of interest in the virtual reality content, the first scent having been determined based on scent preference information associated with the virtual reality device. According to an embodiment, the viewing parameters are determined on the basis of direction of gaze of a user of the virtual reality device. According to an embodiment, the method further comprises providing the first scent for a user in response to receiving the scent instructions, the first scent having been determined based on the transmitted viewing parameters corresponding to the first region of interest. According to an embodiment, the method further comprises providing the first scent for a user in response to determining that current viewing parameters correspond to the first region of interest. According to an embodiment, the method further comprises transmitting the scent preference information of the user by the virtual reality device to the virtual reality server. According to an embodiment, the method further comprises receiving scent instructions from the virtual reality server for providing a second scent, wherein the second scent is associated with a second region of interest in the virtual reality content, the second scent having been determined based on scent information associated with the virtual reality device, and providing the second scent for the user. According to an embodiment, the first region of interest having been determined based on gaze information associated with a plurality of virtual reality devices.

According to a second aspect, there is provided an apparatus comprising at least one processor, at least one memory including computer program code, the at least one memory and the computer program code configured to, with the at least one processor, cause the apparatus at least to transmit viewing parameters associated with displayed virtual reality content to a virtual reality server by a virtual reality device, and receive scent instructions from the virtual reality server for providing a first scent, wherein the first scent is associated with a first region of interest in the virtual reality content, the first scent having been determined based on scent preference information associated with the virtual reality device.

According to an embodiment, the apparatus further comprises a display for displaying virtual reality content, a scent device for providing at least one scent for the user of the virtual reality device, and a gaze tracking sensor for determining a direction of a gaze of a user, wherein the at least one processor, the at least one memory and the computer code are further configured to, with the at least one processor, cause the apparatus to perform a method, wherein, according to an embodiment, the viewing parameters are determined on the basis of direction of gaze of a user of the virtual reality device, or wherein, according to an embodiment, the method further comprises providing the first scent for a user in response to receiving the scent instructions, the first scent having been determined based on the transmitted viewing parameters corresponding to the first region of interest, or wherein, according to an embodiment, the method further comprises providing the first scent for a user in response to determining that current viewing parameters correspond to the first region of interest, or wherein, according to an embodiment, the method further comprises transmitting the scent preference information of the user by the virtual reality device to the virtual reality server, or wherein, according to an embodiment, the method further comprises receiving scent instructions from the virtual reality server for providing a second scent, wherein the second scent is associated with a second region of interest in the virtual reality content, the second scent having been determined based on scent information associated with the virtual reality device, and providing the second scent for the user, or wherein, according to an embodiment, the first region of interest having been determined based on gaze information associated with a plurality of virtual reality devices.

According to a third aspect, there is provided a method comprising: receiving viewing parameters associated with virtual reality content from a plurality of users, determining at least one region of interest in the virtual reality content based on the viewing parameters received from the plurality of users, obtaining scent information for at least one first user of the plurality of users, determining a first scent on basis of the scent information of the first user, and providing scent instructions, wherein the scent instructions comprise instructions for a virtual reality device to provide the first scent, wherein the first scent is associated with the region of interest in the virtual reality content.

According to an embodiment, the scent preference information of the first user is received from the virtual reality device.

According to a fourth aspect, there is provided an apparatus comprising at least one processor, memory including computer program code, the memory and the computer program code configured to, with the at least one processor, cause the apparatus to obtain scent preference information for at least one first user of a plurality of users, receive viewing parameters associated with virtual reality content from the plurality of users, determine at least one region of interest in the virtual reality content based on the viewing parameters received from the plurality of users, receive one or more first viewing parameters from the first user, determine if the first viewing parameters correspond to the region of interest, and in response to determining that the first viewing parameters correspond to the region of interest, provide scent instructions to a virtual reality device associated with the first user to provide a first scent, wherein the first scent is associated with the region of interest in the virtual reality content and wherein the first scent is determined based on the scent preference information of the first user.

According to an embodiment, the computer program code, the memory and the computer program code are further configured to, with the at least one processor, cause the apparatus to perform the method comprising receiving viewing parameters associated with virtual reality content from a plurality of users, determining at least one region of interest in the virtual reality content based on the viewing parameters received from the plurality of users, obtaining scent information for at least one first user of the plurality of users, determining a first scent on basis of the scent information of the first user, and providing scent instructions, wherein the scent instructions comprise instructions for a virtual reality device to provide the first scent, wherein the first scent is associated with the region of interest in the virtual reality content, or, wherein, according to an embodiment, the scent preference information of the first user is received from the virtual reality device.

### DESCRIPTION OF THE DRAWINGS

In the following, various embodiments of the invention will be described in more detail with reference to the appended drawings, in which

FIG. 1 shows a virtual reality device comprising a scent device according to an example embodiment;

FIG. 2 shows a virtual reality device comprising a scent device according to an example embodiment;

FIG. 3 shows a display of a virtual reality device comprising a scent device according to an example embodiment;

FIG. 4 shows a display of a virtual reality device comprising a scent device according to an example embodiment;

FIG. 5 shows a method performed by a virtual reality device according to an example embodiment; and

FIG. 6 shows a method performed by a virtual reality server according to an example embodiment.

### DESCRIPTION OF EXAMPLE EMBODIMENTS

There are three different types of memories categorized based on the amount of time that memory lasts: sensory memory lasting for less than one second, short-term memory storing information for a short period and the longest memories, long-term memory, divided into two further main types: implicit memory and explicit memory. The implicit memory is unconscious memory of skills to perform a task, such as tying a shoelace, playing a guitar or riding a bike. The explicit memory is an ability to recall and recognize the previous experience consciously.

Humans have five basic senses: sight, smell, sound, taste, touch. Each of these sensory memories is separately kept in human brain. As a human brain processes information, the brain ties all of sensory memories and personal impressions into relationships. For example, when people perceive a cat, their experience is the combination of different simple qualities, such as seeing the color, hearing the purr, feeling the fur, and smelling “CatMix”. The combination of these simple qualities comes only through experience. In short, this relationship itself is the memory of the event and experience.

The sense of sight is the ability to memorize and identify the information that is seen. The hearing is also one of important human senses to identify the surroundings. The impression of touch is formed from several modalities including pressure, skin stretch, vibration and temperature. The haptic technology has been providing touch sensation in virtual and real environments. The sense of taste is the sensory ability to distinguish flavour or other substances. Taste and smell are separate senses with their own receptor organs, yet they are intimately entwined.

The sight and hearing are usually believed to be the two most important senses for human survival; however, it is smell that gives human the immediate and direct access to the information in the memory. Smell effectively unlocks forgotten memories on a personal level than any other senses. The information of smell is never actually lost, because the new neurons constantly replace the dead neurons storing smell information. Human may identify approximately 10,000 different smells and each odorant receptor may recognize multiple smells, and a single smell can be recognized by multiple odorant receptors. Smells are translated into personal smell dictionary in a human brain and afterwards sensed smell may transport the human back to the time and place. The sense of smell is synthetic and affected by personal experience.

Therefore there is interest in the use scents in addition to visual and audio solutions while creating experiences and influencing people's behavior in many areas.

A heat map visually represents where, for example, users of virtual reality devices, for example, virtual reality headsets or head-mounted displays (HMD), are looking at while watching virtual reality content, for example, 360 videos or video game environment, and offers an overlay giving a sense of where to the users are gazing the most. Those most looked locations, hot spots of heat maps or heat maps in general, may also be called regions of interest. Color spectrums, gradients or numbers may be used for showing regions of interest and how looking and gazing are distributed over the area. Heat maps are a way to visualize that can effectively reveal the focus of visual attention i.e. gaze in virtual reality content for dozens or even hundreds of participants at a time. Gaze direction of a user may be detected by a gaze tracker if such a sensor is available in virtual reality device 200. Alternatively, the user's gaze direction may be estimated based on the user's head orientation, i.e., based on tracked orientation of the virtual reality device 220.

A heat map may visualize density of gaze directions of a plurality of users. While a heat map may be sometimes visualized as a color map with different colors representing different gaze densities, the heat map may in general comprise any form of data representing gaze density of a plurality of users, for example an array representing gaze density at different regions of virtual reality content. The regions may comprise a pixel or a group of pixels. In one embodiment, plurality of heat maps may be determined for virtual reality content. The plurality of heat maps may be determined based on gaze directions of different groups of users. These groups of users may be selected based on various criteria, for example at least one of the following: one or more predetermined user identifiers, one or more social network relationships, one or more memberships of organizations, one or more user interests such as hobbies, and one or more previously purchased products. In general, the groups of users may be determined based on a user profile, which may be stored on server 220 or received from virtual reality device 200. The term “virtual reality” covers in context of this application also the term “augmented reality” or “mixed reality”.

There are many everyday application areas and service providers that can find value from heat maps created on the basis of gaze tracking data received from virtual reality devices showing different virtual reality content. Some application areas and service providers may utilize heat maps in their operations and some may provide experiences by virtual reality devices, wherein heat maps are taken into account when virtual reality experiences are created. Data-driven marketers, real estate agents, educators and building designers are examples of service providers, which may utilize heat maps as such.

Often virtual reality devices comprise several sensors. In addition to camera sensor(s) they may comprise, for example, audio sensors or microphones. Virtual reality devices are often connected to additional sensors, for extending and/or improving the virtual reality environment experience or widening or improving information received from the environment. Audio and camera sensors of virtual reality devices may be used as high-content sensors. These sensors may carry a large amount of content that is essential for interpretation of the activities in a virtual reality environment. Microphones may provide a higher-quality audio stream for speech recognition. Other types of sensors integrated or connected to virtual reality devices are used to augment the environment. Those sensors may be, for example, sensors detecting which furniture is in use, or touch-sensitive floor tracking people walking. Also bio-sensors may be used for measuring biological data that can be used for providing information about the internal state of the user wearing the virtual reality device. The data from microphones, additional sensors in the environment, and data from bio-sensors can be merged with camera and audio sensor data in order to offer a more complete knowledge about the user's context and in order to create a more complete virtual reality environment.

In virtual reality applications it is important to understand what is happening in the physical world. To achieve contextual knowledge of the space that is being sensed and to model the environment and the people within, methods for both low-level and high-level processing and interpretation are required. These systems may be called as context-aware systems. Signal processing methods are built to process the sensory data captured by the sensors and to model and recognize the space, people, and activities in it.

The activities of the people configured to be modelled can be detected by recognition of identity, location, expression/gesture, audio processing or pose tracking method, or by any other suitable method. For example, a location of people may be detected by using visual and tactile tracking. Hand gesticulation or facial expression may also give additional information about the activities of the people in question and to be interpreted in context of the interactive narrative scenario. The actions performed by the people in a physical space may be various and ambiguous, since people can take different positions in the environment or different combinations with the physical objects. Context-aware systems can be implemented in many ways, and by using different kinds of sensors or different kinds of combinations of sensors. Suitable sensors to be selected and used for modelling may be, for example, a light sensor measuring light intensity, density, reflection, color temperature and type of light, camera measuring visual information, audio sensor measuring audio information, accelerometer measuring motion and acceleration of an object, location sensor measuring position, location and proximity of objects or users, touch sensor detecting touch by implementing skin conductance, conductive planes or light sensors, temperature sensor providing information of temperature, air pressure sensor providing information of altitude changes in pressure, passive infrared (IR) sensor providing information about motion or presence, magnetic field sensor providing information of direction of a device or movement, bio-sensors measuring skin resistance, blood pressure or heart rate or some other specialized sensor, for example, mechanical or chemical sensors added together to augment the sensor capabilities.

Regions of interest of virtual reality content determined on the basis of viewing parameters received from a plurality of users of virtual reality devices that were watching the virtual reality content by their virtual reality devices e.g. virtual reality headsets may be utilized in example embodiments of the invention when providing additional experience for users arranged to be watched the same virtual reality content. The additional experience in example embodiments of the invention is a scent i.e. an odor or a smell. Some application areas or service providers may not utilize heat maps of virtual reality content as such at all or at least not effectively enough so that they take advantage of heat maps in their virtual reality content or they cannot utilize the whole potential of heat maps, but they could take advantage of heat maps more effectively if at least one scent is provided for a user while he/she is watching a virtual reality content. Heat maps combined with at least one scent may be utilized, for example, in the following application areas: marketing, advertising, education, learning, entertainment and games, entertainment such as cinema and sports, mirror world maps, virtual tourism, journalism, documentaries, art, wellness, therapy and relaxation professionals, storytelling, presence and activity awareness alertness and affect, smellscapes (smellwalks in city) and conjunction with other media.

Virtual reality devices may provide scents by any suitable means or device suitable for providing scents for a user of a virtual reality device. These means and devices suitable for providing scents may be called as scent devices. A scent device using smells to immerse a user may be an integrated part of a virtual reality device or the scent device may be arranged near a nose of a user, so that it may provide at least one scent for the user of the device to be smelled. One example of an existing scent device is a sensory mask, which is arranged to be worn by a user with a virtual reality headset. The sensory mask may look like a gas mask. It may include air vents on either side with canisters in the front, over top of user's mouth. Users can choose from different odors to be provided while watching entertainment on their virtual reality headsets. The sensory mask heats up the aromas provided for the viewer as immersive experience. The user can further customize the experience. The user can choose multiple scents at once or just sample each scent individually. Also, the user can choose how heavy or light each aroma is. However, nowadays the existing sensory mask or any other means do not provide scents for the user of a virtual reality device on the basis of the heat maps of a virtual reality content nor on the basis of the shown virtual reality content or objects that are shown in the virtual reality content as is done in the embodiments of the present invention.

In the embodiments of the present invention a scent or scents is/are arranged to be provided to a user of a virtual reality device on the basis of a region of interest or regions of interest of the watched virtual reality content when viewing parameters transmitted by a virtual reality device to a virtual reality server correspond a region of interest and if a predetermined gaze detection criteria is fulfilled, if the predetermined criteria is in general determined. A region of interest may correspond a heat map in the virtual reality content, but it may also be an object or location in the content that a user is wanted to be looking at, for example, for sake of an advertisement. A region of interest may be determined as a portion of a heat map. The gaze detection that is determining of viewing parameters may be performed by an eye detection sensor or by a gaze tracking sensor integrated into a virtual reality device or arranged in connection with a virtual reality device so that gaze tracking is possible. Predetermined gaze detection criteria may be one of the following examples or a combination of following examples: the user looks at the heat map(s) or a specific portion of it (them) or a specific location or object in the environment for a predetermined time period, user's distance is near enough to heat map or a portion thereof, or user looks at several heat maps in the sequence or in specific order. User may be defined to look for a predetermined time period, for example, when a gaze direction of a user corresponds to a predetermined threshold in the heat map. A predetermined threshold may correspond to a gaze direction being within a predetermined distance from a portion of a heat map. User's distance to a portion of a heat map in 2D case, may be defined to be near enough on the basis of the difference of a gaze orientation of the user and the center or the border of a cluster of gaze directions and in 3D case, on the basis of distance of the position of the user to the position of a cluster of user positions and/or difference of gaze orientation of the user and the orientation of the cluster of gaze directions. When user looks at several heat maps in the sequence or in specific order, the content creator can provide scents in the desired order so that different smell is experienced, when the gaze is directed to different locations. For example, in an advertisement, bad smell may be provided at a first location showing a human without deodorant and then the good smell at a second location showing a human with deodorant. In that case the scent is selected by the advertiser and on the basis of the displayed object. In this case the scent is selected for the user. It is also possible to provide scents on the basis of preferences of a user of a virtual reality device i.e. the user may select scents she/he likes. When user has selected her/his preferable scents by herself/himself, a favorite scent of the user may be provided for the user, for example, when her/his gaze is directed to a center of a heat map or a predetermined location or object. The scent may be selected by the user in different ways, for example, by directly asking to enter the smells she/he likes or dislikes, or by asking to rate different smells. User may also be asked to provide general background information about her/his age, gender, hobbies, interests, music preferences, purchase needs, or food interests, and these can then be used to indirectly predict the smells she/he likes or dislikes. In addition, user's reactions to different smells that the virtual reality device emits may be collected and analyzed in order to find favorite scents. For example, activity of head movements can give the information about user's activity level: slow, passive, active, normal). User's emotional state may also be measured using measured biosignals or facial expressions. These observations may be stored and used to create a scent profile. Users may also be classified into groups based on their smell preferences, and/or other parameters such as age, gender, interest, opinions etc. The classification can be used to predict user's reactions to smells that she has not experienced yet. For example, if 90% of the users in the same group like the smell of perfume X, the user probably also likes it even if she/he has not smelled it before.

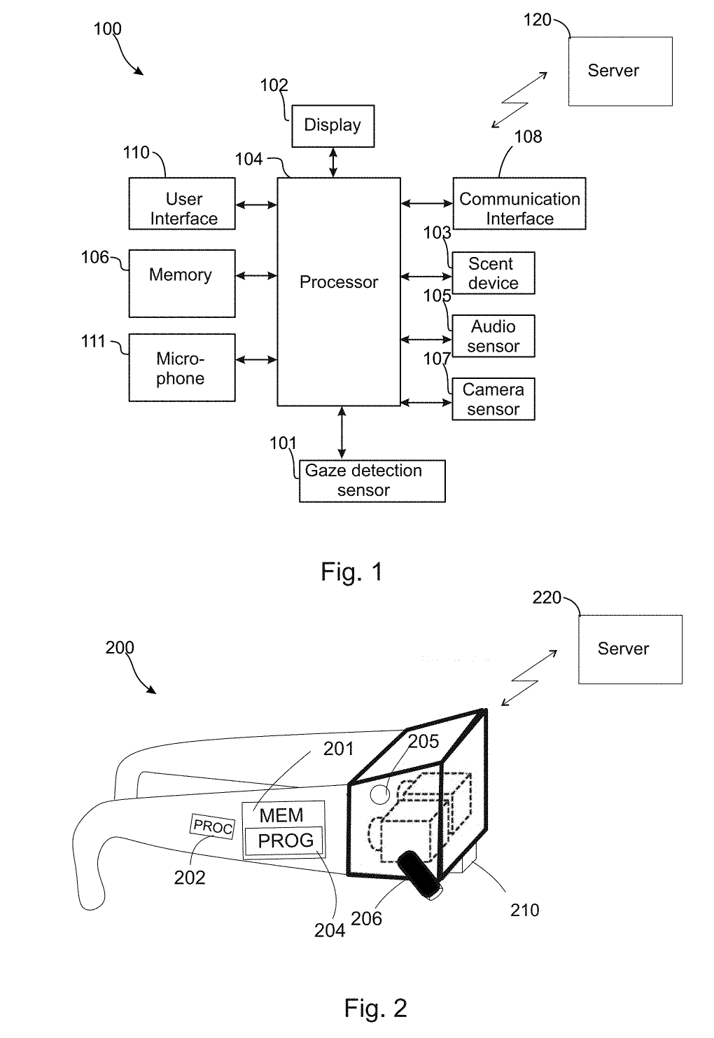

FIG. 1 shows an example of a virtual reality device 100 comprising a scent device 103 according to an example embodiment. The virtual reality device 100 comprises also a display 102 arranged to display virtual reality content and/or other wide view video content. The scent device 103 is arranged to provide at least one scent i.e. smell for the user of the virtual reality device 100, for example, according to at least one predetermined gaze direction criteria while the user watches the virtual reality content. The virtual reality device 100 comprises also at least one eye detection sensor or gaze tracking sensor 101 integrated into the virtual reality device 100 or arranged in connection with the virtual reality device 100 for determining of viewing parameters of the user. The gaze tracking sensor 101 may be an infrared sensor or camera sensor. On the basis of the gaze detecting data i.e. the viewing parameters of the user, a virtual reality server 120 may determine if the gaze is directed to the region of interest i.e. viewing parameters of the user correspond to the region of interest and also if the at least one predetermined gaze direction criteria is fulfilled. It should be noted, that it is possible that the only predetermined gaze direction criteria is that the gaze is directed to the region of interest i.e. viewing parameters of the user correspond to the region of interest. In addition the at least one scent arranged to be provided may depend on whereto the gaze is directed, for example, into which region of interest of many regions of interest of the virtual reality content or into which part of a heat map of the virtual reality content.

The virtual reality device 100 may further comprise other sensors in addition to at least one gaze tracking sensor 101 for providing better virtual reality experience. Those sensors may be, for example, a camera sensor 107, an audio sensor 105 and a microphone 111. Other possible sensors suitable to be used for providing better virtual reality experience in connection with the virtual reality device 100 are, for example, sensors for detecting which furniture is in use, or touch-sensitive floor that tracks people walking or bio-sensors for measuring biological data providing information about the internal state of the person wearing a virtual reality device. These sensors may be connected to the virtual reality device 100 or they may be integrated to the virtual reality device 100. The data from additional sensors in the environment and data from bio-sensors can be merged with camera sensor 107 data and audio sensor 105 data by the virtual reality sensor 120.

The virtual reality device 100 may also comprise a processor 104 comprising processor circuitry for controlling the operations of the virtual reality device 100. There may also be a memory 106 for storing data and computer code to be executed by the processor 104, and a transceiver 108 for communicating with the virtual reality server 120 and/or other devices in a wireless and/or wired manner. The virtual reality device 100 may further comprise a user interface (UI) 110 for displaying information to the user, for generating audible signals and/or for receiving user input. However, the virtual reality device 100 needs not comprise each feature or sensor mentioned above, or it may comprise other features or sensors as well. Server 120 may comprise one or more similar elements to those described for virtual reality device 100. Server 120 may comprise a remote server that is accessible over a communication network, for example the Internet. Server 120 may comprise a local server that is accessible over a local wireless network connection, such as for example Wi-Fi or other short-range wireless connection, or a wired connection, such as for example Universal Serial Bus, USB, or Mobile High Definition Link, MHL. According to an embodiment, server 120 or functionality similar to server 120 may be integrated in one virtual reality device 100, which may act as a server for one or more other virtual reality devices.

It should be noted that although in FIG. 1 only one processor block is shown, the processor 104 may also comprise two or more separate processing units such as a controller and a graphics processing unit. Furthermore, a processor may comprise one or more processing cores.

These elements provide means for performing functions as described in one or more of the appended claims and throughout the specification. For example, according to an embodiment an apparatus comprises means for transmitting viewing parameters associated with displayed virtual reality content to a virtual reality server, and means for receiving scent instructions from the virtual reality server for providing a first scent, wherein the first scent is associated with a first region of interest in the virtual reality content, the first scent having been determined based on scent preference information associated with the virtual reality device.

According to an embodiment an apparatus comprises means for receiving viewing parameters associated with virtual reality content from a plurality of users, means for determine at least one region of interest in the virtual reality content based on the viewing parameters received from the plurality of users, means for obtain scent preference information for at least one first user of the plurality of users, means for receiving one or more first viewing parameters from the first user, means for determining if the first viewing parameters correspond to the region of interest, and means for providing, in response to determining that the first viewing parameters correspond to the region of interest, scent instructions to a virtual reality device associated with the first user to provide a first scent, wherein the first scent is associated with the region of interest in the virtual reality content and wherein the first scent is determined based on the scent preference information of the first user.

In accordance with an embodiment, the virtual reality device 100 and the scent device 103 are controlled by the virtual reality server 120, wherein the virtual reality device 100 and the scent device 103 and the virtual reality server 120 may communicate with each other and a user may use a user interface of the virtual reality server 120 for entering commands, parameters, etc. and the user may be provided information from the virtual reality device 100 via the user interface of the virtual reality server 120. Furthermore, the virtual reality server 120 may transmit the virtual reality content arranged to be displayed by the virtual reality device 100 and the virtual reality server 120 may transmit information of at least one scent arranged to be provided when users gaze is directed to a region of interest according to a possible predetermined gaze direction criteria. One possible virtual reality server 120 for transmitting the virtual reality video content, a region of interest information and information of scent or smell objects that are linked to the regions of interest with different interaction parameters and for determining whether viewing parameters correspond the region of interest in the virtual reality content may be, for example, a mobile phone, or computer or any other device suitable to be used for above mentioned purpose.

FIG. 2 shows another example of a virtual reality device 200 comprising a scent device 210 according to an example embodiment. The virtual reality device 200 may be connected to a virtual reality server 220. As shown in FIG. 2, the virtual reality device 200 contains a memory 201, at least one processor 202, and a computer program code 204 residing in the memory 201. The virtual reality device 200 comprises at least one camera 205 for capturing image data, for example, video streams. The camera 205 may be inside-looking, e.g. an infrared camera looking towards the user of the device and arranged for gaze tracking. The virtual reality device 200 may comprise at least one further camera 206 that may be side down-looking, trained on one hand of the user and arranged for hand gesture tracking. The virtual reality device 200 also comprises a screen i.e. a display 207, for displaying virtual reality content and a graphical user interface, and a scent device 210 for providing at least one scent determined on the basis of a gaze direction of a user of the virtual reality device 200, wherein the scent is determined by the virtual reality server 220 on the basis of the viewing parameters of the user provided by the gaze tracking camera 206 and transmitted to the virtual reality server 220. The virtual reality device 200 may also contain one or more wireless or wired microphones or any suitable audio input which may be digital or analogue signal input attached thereto. In addition, the virtual reality device 200 may also comprise a rechargeable battery (not shown) or another suitable mobile energy device, such as a solar cell, fuel cell or clockwork generator. The virtual reality device 200 may further comprise an infrared port for short range line of sight communication to other devices. The infrared port may be used for obtaining i.e. receiving virtual reality content and scent information. However, the virtual reality content may also be provided by some other device or it may be stored in the memory of the virtual reality device. In other embodiments, the virtual reality device 200 may further comprise any suitable short range communication solution, such as for example a Bluetooth or Bluetooth Smart wireless connection or a USB/firewire wired connection. In addition, because the virtual reality device 200 acts as a display for the virtual reality server 220, there may be wired or wireless connection between the virtual reality device 200 and the server 220.

The virtual reality device 200 and server 220 may be connected via a fixed network, such as the Internet or a local area network, or a mobile communication network, such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks to other devices and a virtual reality server. Different networks may be connected to each other by means of a communication interface. The networks comprise network elements, such as routers and switches for processing data (not shown), and communication interfaces, such as the base stations in order to provide access to the network for the different devices, and the base stations may be themselves connected to the mobile network via a fixed connection or a wireless connection.

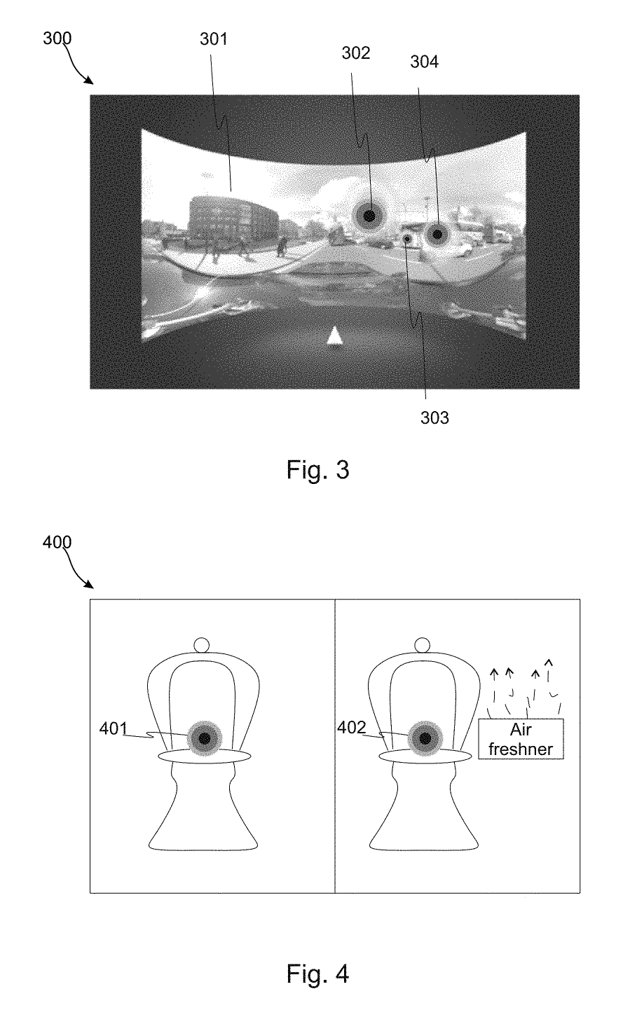

FIG. 3 shows a display 300 of a virtual reality device comprising a scent device (not shown) according to an example embodiment. The display 300 is arranged to display virtual reality content and/or other wide view video content. In FIG. 3, it is shown a virtual reality environment 301. On the virtual reality environment 301 there are shown 3 regions of interest 302, 303, 304. As discussed above, a heat map may be determined, for example at video server 220, based on head orientation and/or gaze direction information from a plurality of virtual reality display devices 200. This information may be received from the virtual reality devices as one or more messages comprising at least one of the following information fields: orientation of the virtual reality device (e.g. as yaw, pitch, and roll angles), gaze direction with respect to the display of the virtual reality device, a time stamp or a content identifier associated with the displayed virtual reality content, and a user identifier. Based on receiving one or more of these parameters from a plurality virtual reality devices, the video server 220 may determine a portion of the virtual reality content as a region of interest, corresponding to a heat map of gaze directions.

If a gaze of a user is detected to be directed to one of the regions of interest according to a predetermined gaze detecting criteria i.e. if a virtual reality server determines that viewing parameters of the user correspond one of the regions of interest 302, 303, 304 according to the predetermined gaze detecting criteria (if determined), the virtual reality server transmits scent instruction to the virtual reality device and at least one scent defined by the scent instruction is provided for the user by the scent device. Scent instructions may comprise one or more of the following parameters: an identifier of at least one scent, an intensity of at least one scent, at least one time instant or at least one time period for providing a scent, at least one spatial location or at least one region of interest associated with a scent. According to an embodiment, the scent instructions comprise a plurality of scent identifiers to cause a virtual reality device to provide a combination of the signalled scents to a user. Based on the one or more scent identifiers, a virtual reality device 100 is able to provide the intended scent(s) to the user.

There may be a different scent for each the regions of interest 302, 303, 304 and the scent device is arranged to provide the at least one scent i.e. smell for the user of the virtual reality device if user gaze is directed to one of the regions of interest 302, 303, 304 according to at least one predetermined gaze detection criteria of the regions of interest in question. Example 1: if a gaze of a user is determined to be directed to a first region of interest 302 according to a predetermined first gaze direction criteria that is in this example a time period of one second, a predetermined first scent that may be, for example, a smell of a pine is provided by the scent device. Example 2: if the gaze of the user is determined to be directed to a second region of interest 303 according to a predetermined second gaze direction criteria that is, in this example, that the gaze is directed to the second region of interest 303 twice per second, a predetermined second scent that is, for example, a smell of coffee is provided by the scent device. Example 3: if the gaze of the user is determined to be directed to a third region of interest 304 according to a predetermined third gaze direction criteria that is, in this example, that the gaze is directed to the third region of interest 304 after the second region of interest 303, a predetermined third scent that is, for example, a smell of a fresh pastry is provided by the scent device. It is also possible that a different scent is provided from the same region of interest when the predetermined criteria are fulfilled the second time, third time, fourth time etc. For example, if the if the gaze of a user is determined to be directed for the second time to the first region of interest 302 according to the predetermined first gaze direction criteria that is again the time period of one second, a predetermined fourth scent that is, for example, a smell of a spruce is provided by the scent device. Alternatively, the strength of the scent could be increased.

Dynamic behavior of the heat map or region of interest over a time period may be also considered in scent selection (e.g. weak scent, normal scent, strong scent, or type of scent selection). For example, an increasing gaze density at a region of interest may cause a strength of the scent to increase. A decreasing gaze density may cause the strength of the scent to decrease. When multiple heat maps are used for different groups of users, changes in the composition of the groups may cause a different scent to be selected for a particular user. Interactions between users in the virtual reality may be also used as basis for determining scent for the interacting users. In one example, the same scent and/or a same level of scent may be selected for the interacting users. In another example, the interacting users may be assigned to the same group of users that contribute to determination of the same heat map.

The scent may be selected/determined by the user on the basis of his/her own scent preferences, and/or on the basis of the object shown in the heat map or the scent may be selected on the basis of the video content provided for the users. At least one scent selected by a user may be called as scent preference information. And, for example, if the scent preference information is determined by the user, the determined scent preference information may be transmitted, for example, by the virtual reality device to a virtual reality server that is arranged to provide virtual reality content for virtual reality devices and the virtual reality server determines at least one scent for the virtual reality content on the basis of the transmitted scent preference information. The server may store a plurality of user profiles comprising the scent preference information. Scent preference information of a user may be associated at the server with a virtual reality device of the user. Viewing parameters associated with virtual reality content are transmitted to the virtual reality server by a plurality of virtual reality devices or their users. On the basis of a plurality of viewing parameters received from the plurality of devices of users the virtual reality server may determine at least one region of interest in the virtual reality content. A scent associated with that region of interest may be then determined for one or more of the plurality of users separately. Determining the one or more scents may be based on the user profiles comprising scent preference information. In some embodiments the scent preference information is received from the virtual reality device 200. The scent preference information may be also determined by server 220 based on other user profile information. The determined region of interest may correspond to a heat map. Scent preference information, or scent information, may comprise one or more preferred scent, which may be identifier by a scent identifier in the scent preference information.

When a user after this watches the same virtual reality content, the virtual reality device transmits one or more viewing parameters of the user to the server. The virtual reality server compares those viewing parameters of the user to determined region of interest, and if they correspond, the virtual reality server may then transmit scent instructions to the virtual reality device. The scent instruction comprises instruction about which is the scent that is associated with the region of interest and that should be provided for the user. In other words, if the one or more first viewing parameters (e.g. gaze direction of a first user) are determined by a virtual reality server to correspond to the region of interest also determined by the virtual reality server on the basis of viewing parameters transmitted by a plurality of individual virtual reality devices beforehand, the virtual reality device, in response, provides the scent for the user, defined in the scent information received from the virtual reality server. And as already said above, the at least one scent defined in the scent information may be determined by the first user, in which case his/her favorite smells may be used or the used at least one scent may be determined by the virtual reality server so that the used at least one scent fits/corresponds to the virtual reality content and/or content of the region of interest. As an example, the virtual reality server may send a first message comprising at least one first scent instruction to a first virtual reality device, which may be associated with a first user. The server may also send a second message comprising at least one second scent instruction to a second virtual reality device, which may be associated with a second user. The first and second scent instructions may be determined based on user profiles of the first and the second user, respectively.

In one embodiment, a type field of the scent instruction message indicates immediate provision of the scent. In response to this type of scent instruction the virtual reality device provides the scent to the user substantially immediately to the user. The type field of the scent instruction message may also indicate a conditional provision of the scent. In one embodiment, the condition comprises a current viewing direction of the user. This enables the server 220 to determine and send user-specific scent instructions associated with detected regions of interest beforehand. In response to receiving a conditional scent instruction, the virtual reality device is configured to provide the scent to the user after the condition is fulfilled, for example when current viewing parameter(s), for example, a gaze direction, correspond to the region of interest. A scent instruction message may comprise one or more parameters, wherein the parameters define the regions of interest. The parameters may include one or more spatial or angular coordinates to define an area or volume at the virtual reality content as the region of interest.

By this kind of solution, the regions of interest may be used to enable more personal and interactive experience in the virtual reality or augmented reality environment from the end-user's point of view. This is because personalized scent(s) can be linked to selected regions of interest with different interaction parameters to generate unique user experience on the basis of preferences of the user or a user experience, where smell of the virtual reality content corresponds the smell in a corresponding real world.

FIG. 4 shows a display 400 of a virtual reality device comprising a scent device (not shown) according to an example embodiment. An advertisement is shown on the display 400. The viewed content comprises two regions of interest 401, 402 both comprising a region of interest having different scents to be provided, when a virtual reality server determines on the basis of received viewing parameter(s) measured by a gaze tracking sensor of the virtual reality device that a gaze of a user of the virtual reality device is directed to one of them. The first part of the advertisement content comprises the first region of interest 401 in a toilet without an air freshener and the second part of the advertisement content comprises the second region of interest 402 in a toilet with an advertised air freshener. If users gaze is determined to be directed to the first region of interest 401, a bad smell is provided by a scent device of the virtual reality device. And if users gaze is determined to be directed to the second region of interest 402, a fresh smell of ocean is provided by the scent device of the virtual reality device. In this embodiment the predetermined gaze detection criteria is that gaze is just directed to a region of interest. These scents are selected on the basis of the virtual reality content, for example, by the advertiser of the air freshener for the virtual reality server, and transmitted as scent instructions from the virtual reality server to the virtual reality device, when the user's viewing parameter(s) correspond locations of regions of interest 401, 402. According to an embodiment, the good smell associated with region of interest 402 is determined for each user based on respective smell preference information. For example, the fresh smell of ocean may be selected for a user whose user profile indicates preference for a smell of an ocean. Such indication may be for example a water related hobby. For another user the good smell associated with region of interest 402 may be some other smell, for example a smell of forest. In general, the virtual reality server may determine a closest match of the available scents with the user profile. In this example, the scents are selected based on the advertised products such that the smell in the virtual reality environment corresponds to the smell of the advertised product in real world.

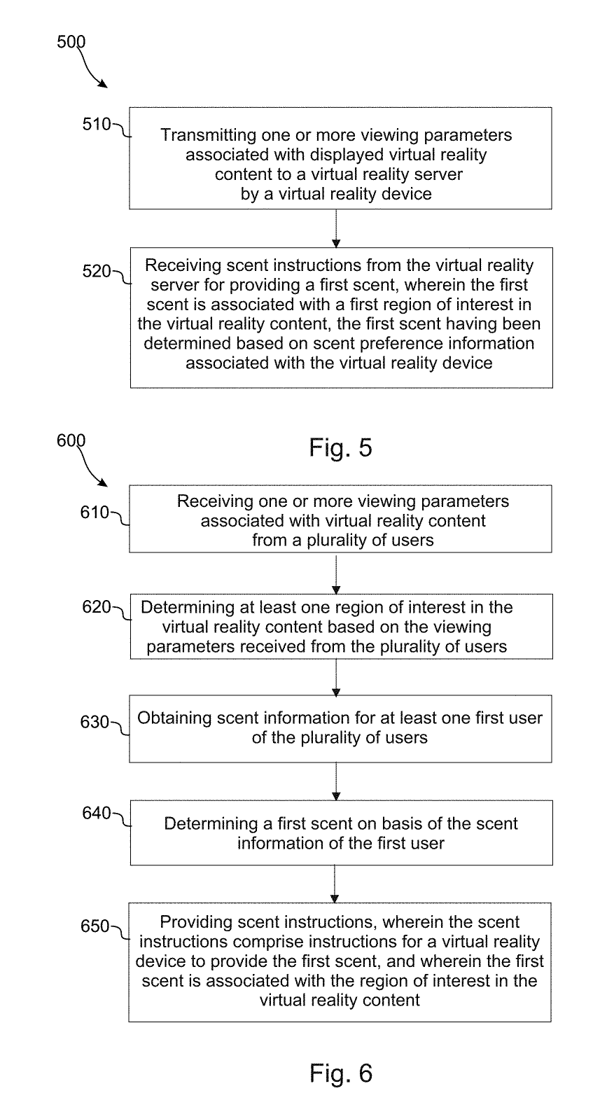

FIG. 5 shows a method performed by a virtual reality device according to an example embodiment. In the method 500, in step 510 viewing parameter(s) associated with displayed virtual reality content are transmitted to a virtual reality server by a virtual reality device, and in step 520 scent instructions are received from the virtual reality server for providing a first scent, wherein the first scent is associated with a first region of interest in the virtual reality content, the first scent having been determined based on scent preference information associated with the virtual reality device.

FIG. 6 shows a method performed by a virtual reality server according to an example embodiment. In the method 600, in step 610 viewing parameter(s) associated with virtual reality content are received from a plurality of users. In step 620, at least one region of interest in the virtual reality content based is determined on the viewing parameters received from the plurality of users. In step 630, scent information for at least one first user of the plurality of users is obtained. In step 640, a first scent is determined on basis of the scent information of the first user, and in step 650, scent instructions are provided. The provided scent instructions comprise instructions for a virtual reality device to provide the first scent, wherein the first scent is associated with the region of interest in the virtual reality content.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1. A method comprising:
transmitting one or more viewing parameters associated with displayed virtual reality content to a virtual reality server by a virtual reality device, and
receiving scent instructions from the virtual reality server for providing a first scent, wherein the first scent is associated with a first region of interest in the virtual reality content, the first scent having been determined based on scent preference information associated with the virtual reality device.

2. The method according to claim 1, wherein the viewing parameters are determined on the basis of direction of gaze of a user of the virtual reality device.

3. The method according to claim 1 further comprising:
providing the first scent for a user in response to receiving the scent instructions, the first scent having been determined based on the transmitted one or more viewing parameters corresponding to the first region of interest.

4. The method according to claim 1 further comprising:
providing the first scent for a user in response to determining that current viewing parameters correspond to the first region of interest.

5. The method according to claim 1 further comprising:
transmitting the scent preference information of a user by the virtual reality device to the virtual reality server.

6. The method according to claim 1 further comprising:
receiving scent instructions from the virtual reality server for providing a second scent, wherein the second scent is associated with a second region of interest in the virtual reality content, the second scent having been determined based on scent preference information associated with the virtual reality device, and
providing the second scent for the user.

7. The method according to claim 1, wherein the first region of interest having been determined based on gaze information associated with a plurality of virtual reality devices.

8. An apparatus comprising
at least one processor,
at least one memory including computer program code,
the at least one memory and the computer program code configured to, with the at least one processor, cause the apparatus at least to:
transmit one or more viewing parameters associated with displayed virtual reality content to a virtual reality server by a virtual reality device, and
receive scent instructions from the virtual reality server for providing a first scent, wherein the first scent is associated with a first region of interest in the virtual reality content, the first scent having been determined based on scent preference information associated with the virtual reality device.

9. The apparatus according to claim 8, wherein the viewing parameters are determined on the basis of direction of gaze of a user of the virtual reality device.

10. The apparatus according to claim 8, further comprising a display for displaying virtual reality content, a scent device for providing at least one scent for the user of the virtual reality device, and a gaze tracking sensor for determining a direction of a gaze of a user, wherein the at least one processor, the at least one memory and the computer code are further configured to, with the at least one processor, cause the apparatus to perform:
provide the first scent for a user in response to receiving the scent instructions, the first scent having been determined based on the transmitted one or more viewing parameters corresponding to the first region of interest.

11. The apparatus according to claim 8, further comprising a display for displaying virtual reality content, a scent device for providing at least one scent for the user of the virtual reality device, and a gaze tracking sensor for determining a direction of a gaze of a user, wherein the at least one processor, the at least one memory and the computer code are further configured to, with the at least one processor, cause the apparatus to perform:
provide the first scent for a user in response to determining that current viewing parameters correspond to the first region of interest.

12. The apparatus according to claim 8, further comprising a display for displaying virtual reality content, a scent device for providing at least one scent for the user of the virtual reality device, and a gaze tracking sensor for determining a direction of a gaze of a user, wherein the at least one processor, the at least one memory and the computer code are further configured to, with the at least one processor, cause the apparatus to perform:
transmit the scent preference information of a user by the virtual reality device to the virtual reality server.

13. The apparatus according to claim 8, further comprising a display for displaying virtual reality content, a scent device for providing at least one scent for the user of the virtual reality device, and a gaze tracking sensor for determining a direction of a gaze of a user, wherein the at least one processor, the at least one memory and the computer code are further configured to, with the at least one processor, cause the apparatus to perform:
receive scent instructions from the virtual reality server for providing a second scent, wherein the second scent is associated with a second region of interest in the virtual reality content, the second scent having been determined based on scent preference information associated with the virtual reality device, and
provide the second scent for the user.

14. The apparatus according to claim 8, wherein the first region of interest having been determined based on gaze information associated with a plurality of virtual reality devices.

15. A method comprising:
receiving one or more viewing parameters associated with virtual reality content from a plurality of users,
determining at least one region of interest in the virtual reality content based on the one or more viewing parameters received from the plurality of users,
obtaining scent information for at least one first user of the plurality of users,
determining a first scent on basis of the scent information of the first user, and
providing scent instructions, wherein the scent instructions comprise instructions for a virtual reality device to provide the first scent, wherein the first scent is associated with the region of interest in the virtual reality content.

16. The method according to claim 15, wherein the scent preference information of the first user is received from the virtual reality device.

17. An apparatus comprising at least one processor, memory including computer program code, the memory and the computer program code configured to, with the at least one processor, cause the apparatus to
receive one or more viewing parameters associated with virtual reality content from a plurality of users,
determine at least one region of interest in the virtual reality content based on the one or more viewing parameters received from the plurality of users,
obtain scent preference information for at least one first user of the plurality of users,
receive one or more first viewing parameters from the first user,
determine if the first viewing parameters correspond to the region of interest, and
provide scent instructions, wherein the scent instructions comprise instructions for a virtual reality device to provide the first scent, wherein the first scent is associated with the region of interest in the virtual reality content.

18. The apparatus of claim 17, wherein the scent preference information of the first user is received from the virtual reality device.
